(19) United States
(12) Patent Application Publication
(10) Pub. No.: US 2010/0143522 A1
(43) Pub. Date: Jun. 10, 2010

(54) MOLDED ARTICLE FORMED USING CRUSHED CHIPS OF THERMOSETTING PLASTIC, AND METHOD AND APPARATUS FOR MANUFACTURING THE SAME

(76) Inventor: Peter Y. Sibbett, N. Tacoma, WA (US)

Correspondence Address: SCHMEISER, OLSEN & WATTS, 22 CENTURY HILL DRIVE, SUITE 302, LATHAM, NY, 12110, US

(21) Appl. No.: 12/706,743

(22) Filed: Feb. 17, 2010

Related U.S. Application Data
(62) Division of application No. 12/265,752, filed on Nov. 6, 2008.

(30) Foreign Application Priority Data
Nov. 7, 2007 (KR) 10-2007-0113078

(51) Int. Cl. B29C 47/36

(52) U.S. Cl. 425/202

(57) ABSTRACT

A molded article formed using crushed chips of a thermosetting plastic, and a method and apparatus for manufacturing the same are disclosed. The method includes performing primary crushing of an article formed from a thermosetting plastic to produce fragments of the article, performing secondary crushing of the fragments of the article with a crusher to produce crushed chips, mixing a resin material and an additive with the crushed chips to produce a molding powder, and performing extrusion molding of the molding powder.

This divisional application claims priority to U.S. patent application Ser. No. 12/265,752 filed on Nov. 6, 2008, the entire disclosure of which is incorporated herein by reference.

### BACKGROUND OF THE INVENTION

1. Field of the Invention

The present invention relates to crushed chips of a thermosetting plastic and, more particularly, to a molded article that is formed by extrusion molding with a mixture of a thermoplastic resin, a foaming agent and crushed chips obtained through primary and secondary crushing of a thermosetting plastic, and a method and apparatus for manufacturing the same.

2. Description of the Related Art

In general, thermosetting plastics comprising a sheet molding compound (SMC) and a bulk molding compound (BMC) are widely used for construction materials, such as doors, ceiling materials, and water tanks; automobile components, such as head lamps and exterior panels of vehicles; electronic components, and the like.

Since a raw material of the SMC and the BMC contains glass fibers in addition to the thermosetting plastics, it is difficult to reuse the SMC and the BMC via a crushing operation.

In more detail, for a molded article formed from the SMC or the BMC containing the glass fibers to be reused as fillers, the glass fibers contained in the article must also be crushed into a fine powder. For this purpose, it is necessary to have a high strength crush blade and a special crusher including the same. However, since such a crush blade and a special crusher cannot be commercially or technically obtained, the molded article containing the glass fibers is generally buried or burnt for disposal, thereby entailing high costs.

In addition, when any one of cutting members used for crushing the article formed from the SMC or the BMC is damaged due to a securing structure of the cutting members with respect to rotational members, all of the rotational members must be replaced with new ones.

Further, since the cutting members are disposed in a linear arrangement, simultaneous contact of the cutting members with a target results in a high operating load, thereby causing malfunction of the crusher. Therefore, there is a need for improvement of these problems in the prior art.

### SUMMARY OF THE INVENTION

The present invention is conceived to solve the problems of the conventional techniques as described above, and an aspect of the present invention is to provide a molded article that is formed using crushed chips of a thermosetting plastic and is capable of preventing an increase in disposal costs and environmental damage relating to landfill or incineration of a molded article comprising SMC and BMC, and a method and apparatus for manufacturing the same.

Another aspect of the present invention is to provide a molded article that is formed by extrusion molding after crushing an article of a thermosetting plastic comprising SMC and BMC into a fine powder for the purpose of reuse of the article, and is capable of preventing an increase in manufacturing costs by eliminating a need for a high strength crush blade and a special crusher, and a method and apparatus for manufacturing the same.

A further aspect of the present invention is to provide a molded article that is formed using crushed chips of a thermosetting plastic and is capable of preventing replacement of all rotational members caused by damage of cutting members secured to the rotational members for crushing a molded article formed from a thermosetting plastic comprising SMC and BMC, and a method and apparatus for manufacturing the same.

Yet another aspect of the present invention is to provide a molded article that is formed using crushed chips of a thermosetting plastic and is capable of preventing malfunction of a crusher by a great operating load generated due to simultaneous contact of linearly arranged cutting members with a target article, and a method and apparatus for manufacturing the same.

In accordance with an aspect of the present invention, a method for manufacturing a molded article with crushed chips of a thermosetting plastic comprises: performing primary crushing of an article formed from a thermosetting plastic to produce fragments of the article; performing secondary crushing of the fragments of the article with a crusher to produce crushed chips; mixing a resin material and an additive with the crushed chips to produce a molding powder; and performing extrusion molding of the molding powder.

The crushed chips may have a particle size of 5˜15 mm.

The thermosetting plastic may comprise at least one of SMC (sheet molding compound) and BMC (bulk molding compound).

The resin material may comprise a thermoplastic resin and the molding powder may contain at most 70% of the crushed chips.

The additive may comprise azodicarbonamide (ADCA) as a foaming agent to decrease a specific weight of the molded article.

In accordance with another aspect of the present invention, a molded article formed using crushed chips of a thermosetting plastic is manufactured by at least one of the methods as set forth above.

In accordance with a further aspect of the present invention, an apparatus for manufacturing a molded article using crushed chips of a thermosetting plastic, including: a crusher to crush fragments of an article of a thermosetting plastic to produce crushed chips, the fragments of the article having been subjected to primary crushing; a mixer to mix a resin material and an additive with the crushed chips to produce a molding powder; and an extruder to perform extrusion molding of the molding powder.

The crusher may include an input port opened at an upper side of the crusher through which the fragments of the article are input; a crushing guide having a curved surface to guide the input fragments of the article to a lower side of the crusher; a blade unit rotatably disposed inside the crushing guide and connected with a motor to crush the fragments of the article to produce the crushed chips; and a screen spaced apart from the blade unit and formed with apertures through which the crushed chips are discharged.

The blade unit may include a rotational shaft to which a rotational force is transmitted from the motor; plate-shaped rotational members rotatably secured to the rotational shaft and spaced at predetermine intervals from each other; and cutting members, each being secured along one side of each rotational member, to crush the fragments.

The cutting members mounted on the rotational members may be spaced from one another at 120 degree intervals around the rotational shaft.

The cutting members may be secured to the rotational members via bolt fastening.

The cutting member may be divided into a left side blade and a right side blade, and the left and right side blades may be mounted in a V-shape on the rotational member to define a central angle of 150˜175 degrees at a central part between the left and right side blades.

The blade unit may have a space defined between the rotational members connected with each other via the rotational shaft and the cutting members to facilitate introduction of the fragments into the blade unit and crushing of the fragments by the cutting members.

The extruder may include an exhaust hole formed at one side thereof to exhaust a gas, and an exhaust member connected to the exhaust hole to forcibly exhaust the gas from the extruder to an outside thereof.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a flowchart of a method for manufacturing a molded article using crushed chips of a thermosetting plastic according to one embodiment of the present invention;

FIG. 2a illustrates fragments of the molded article contained in a conveying case after primary crushing in the method of FIG. 1;

FIG. 2b illustrates a crusher for crushing the fragments of FIG. 2a;

FIG. 2c illustrates a mixer for mixing a resin material and an additive with crushed chips having passed through the crusher of FIG. 2b;

FIG. 2d illustrates an extruder for extrusion molding of a molded article using a molding powder produced by the mixer of FIG. 2c;

FIG. 3 is a side sectional view of the crusher of FIG. 2b;

FIG. 4 is an exposed perspective view of a blade unit of FIG. 3; and

FIG. 5 is a perspective view of the blade unit of FIG. 4.

### DETAILED DESCRIPTION OF THE INVENTION

Exemplary embodiments of the present invention will be described in detail with reference to the accompanying drawings hereinafter. For convenience of description, the formation of a molded article through recycling of a molded door formed from a thermosetting plastic will be described by way of illustration. Here, it should be noted that the drawings are not to precise scale and may be exaggerated in thickness of lines or size of components for descriptive convenience and clarity only. Furthermore, terms used herein are defined by taking functions of the present invention into account and can be changed according to the custom or intention of users or operators. Therefore, definition of the terms should be made according to overall disclosures set forth herein.

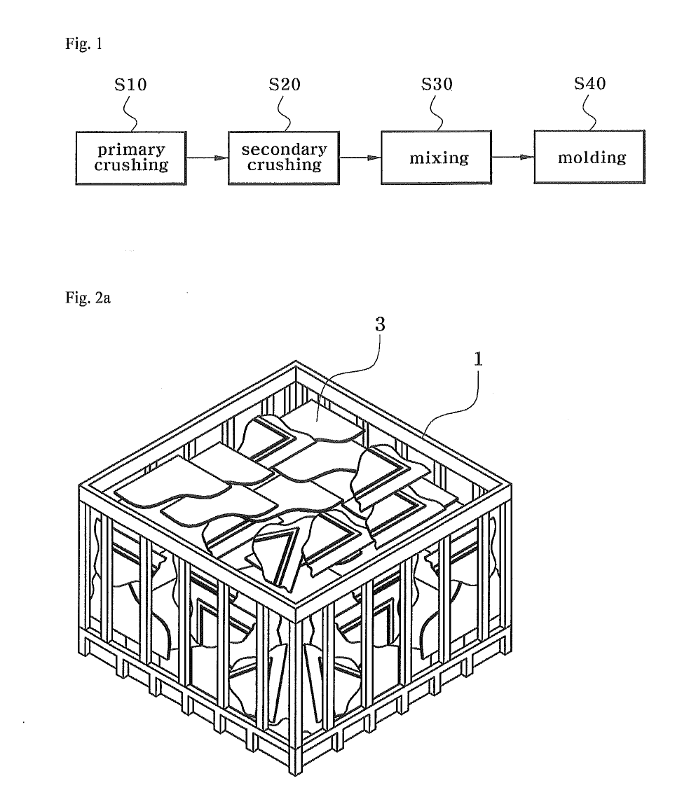

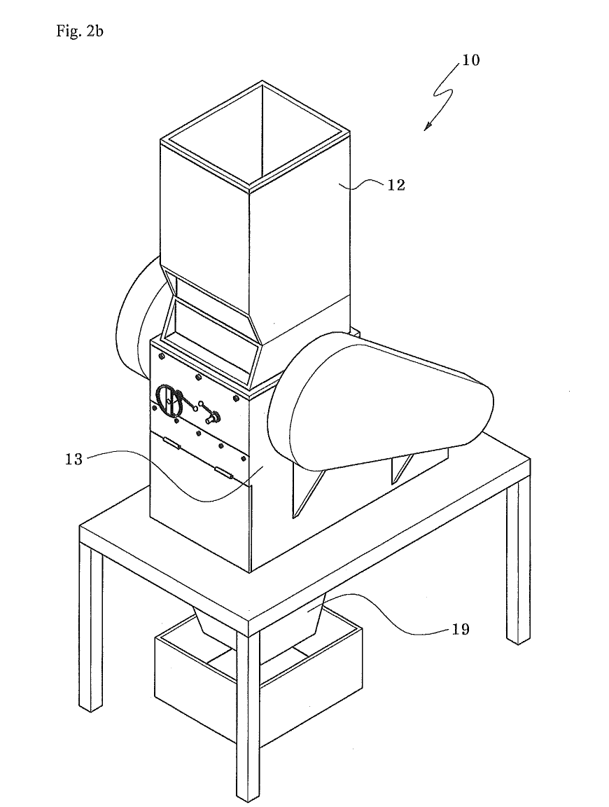

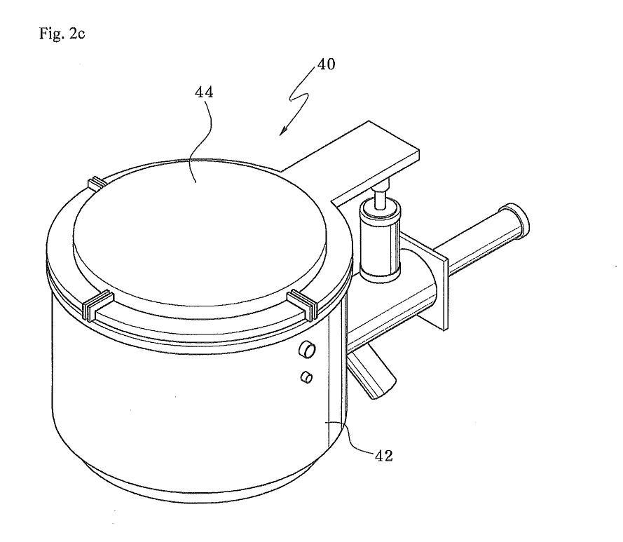

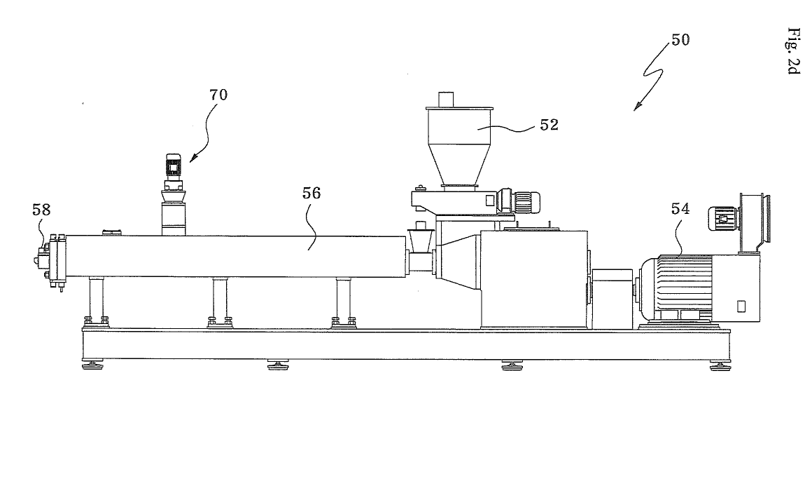

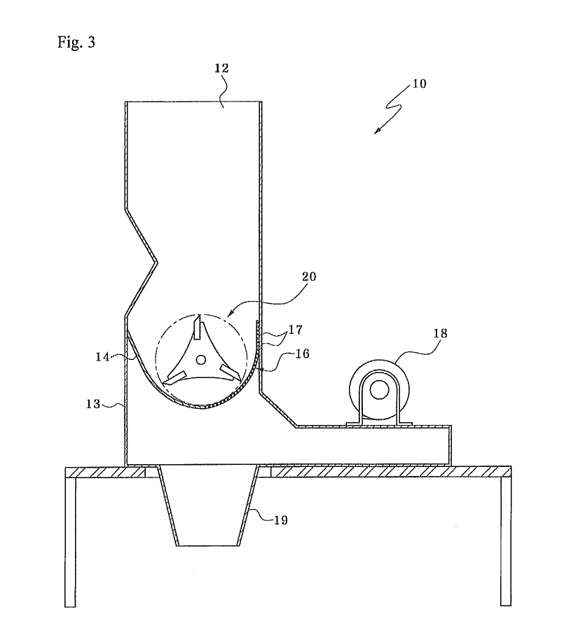

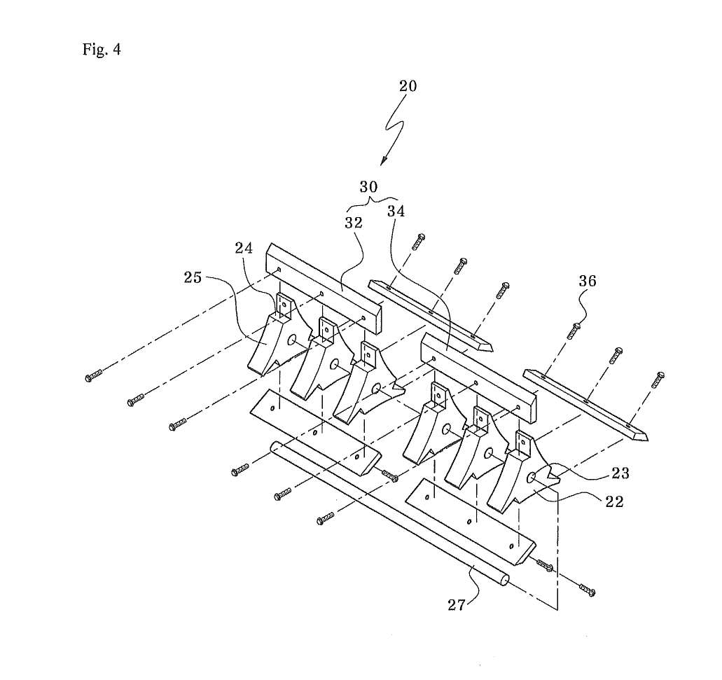

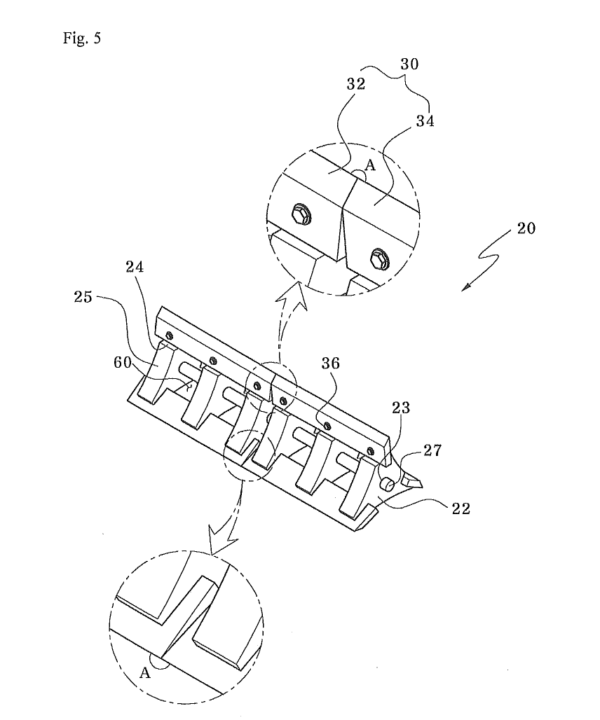

FIG. 1 is a flowchart of a method for manufacturing a molded article using crushed chips of a thermosetting plastic according to one embodiment of the present invention; FIG. 2a illustrates fragments of the molded article contained in a conveying case after primary crushing in the method of FIG. 1; FIG. 2b illustrates a crusher for crushing the fragments of FIG. 2a; FIG. 2c illustrates a mixer for mixing a resin material and an additive with crushed chips having passed through the crusher of FIG. 2b; FIG. 2d illustrates an extruder for extrusion molding of a molded article using a molding powder produced by the mixer of FIG. 2b; FIG. 3 is a side sectional view of the crusher of FIG. 2b; FIG. 4 is an exposed perspective view of a blade unit of FIG. 3; and FIG. 5 is a perspective view of the blade unit of FIG. 4.

Hereinafter, an apparatus for manufacturing a molded article using crushed chips of a thermosetting plastic according to one embodiment of the present invention will be described.

According to this embodiment, the apparatus includes a crusher 10 for crushing fragments 3, which are formed by primary crushing of an article formed from a thermosetting plastic comprising at least one of SMC and BMC, to produce crushed chips; a mixer 40 for mixing a resin material and an additive with the crushed chips, which are supplied from the crusher 10, to produce a molding powder; and an extruder 50 used for extrusion molding of the molding powder, which is supplied from the mixer 40.

The crusher 10 includes an input port 12 opened at an upper side thereof through which the fragments 3 are input, a crushing guide 14 having a curved surface to guide the fragments 3, which have been input through the input port 12, to a lower side of the crusher 10, a blade unit 20 rotatably disposed inside the crushing guide 14 and connected with a motor 18 to crush the fragments 3 to produce the crushed chips, and a screen 16 spaced apart from the blade unit 20 and formed with a plurality of apertures 17 through which the crushed chips are discharged.

The input port 12 is provided at the lower side thereof with a case 13 that constitutes the appearance of the crusher and accommodates the crushing guide 14, the blade unit 20, and the screen 16 therein.

The screen 16 has the plural apertures 17 through which the crushed chips can pass, and each of the apertures has a size of 5 to 15 mm.

The blade unit 20 includes a rod-shaped rotational shaft 27 to which a rotational force is transmitted from the motor 18, a plurality of plate-shaped rotational members 22 rotatably secured to the rotational shaft 27 and spaced at predetermine intervals from each other, and a cutting member 30 secured along one side of each rotational member 22 to crush the fragments 3.

The rotational member 22 has a triangular shape, and each side of the triangular rotational member 22 is concavely rounded to form a round part 25.

The rotational member 22 is formed at the center thereof with a through-hole 23. With this configuration, the rotational shaft 27 rotatably connected with the motor 18 is inserted into the through-hole 23 of the rotational member 22 and is then welded thereto.

The plural rotational members 22 are spaced at constant intervals from each other.

Further, each of the rotational members 22 has a stepped latch 24 formed at an edge thereof to mount the cutting members 30 thereon, so that the cutting members 30 are spaced from one another at 120 degree intervals on each rotational member 22 around the rotational shaft 27.

The cutting members 30 and mounting surfaces of the stepped latches 23 are formed with fastening holes into which bolts 36 are screwed to fasten the cutting members 30 to the stepped latches 23 of the rotational members 23.

That is, since the cutting members 30 are fastened to the rotational members 22 by the bolts 36, only an associated cutting member 30 need be separated therefrom for maintenance or repair.

An even number of rotational members 22 are provided and divided into right and left sides of the blade unit 20, and each of the cutting members 30 mounted on the rotational members 22 is also divided into a left blade 32 and a right blade 34.

As shown in FIGS. 4 and 5, in this embodiment, the blade unit 20 includes six rotational members 22, three of which are located at the left side of the blade unit 20 and coupled to the left side blade 32, and the other three of which are located at the right side of the blade unit 20 and coupled to the right side blade 34.

Here, the left side blade 32 and the right side blade 34 are mounted in a V-shape on the rotational member 22 to define a central angle A of 150˜175 degrees at a central part between the left side blade 32 and the right side blade 34.

The V-shaped mounting of the left side blade 32 and the right side blade 34 is designed to minimize load of the crusher during a crushing operation by allowing the left side blade 32 and the right side blade 34 to contact the fragments 3 at an angle from one side of the left side blade 32 and the right side blade 34 instead of simultaneously contacting the fragments 3 when the blade unit 30 is rotated to crush the fragments 3.

Further, the blade unit 20 has a space 60 defined between the rotational members 22 connected with each other via the rotational shaft 30 and the cutting members 27 to facilitate introduction of the relatively larger fragments 3 into the blade unit 20 and crushing of the fragments 3 by the cutting members 30.

The mixer 40 includes a mixer body having a rotational mixing blade disposed therein, and a mixer cover 44 covering an upper side of the mixer body.

The extruder 50 includes a generator 54 for transmitting rotational power, a supply part 52 through which the molding powder is input, an extruder body 56 having one or two screws mounted in the extruder body 56 and rotated by the generator 54, and an ejection port 58 through which a molded article is compressed forward and ejected from the extruder body 56.

After being supplied through the supply part 52, the molding powder moves along the extruder body 56 having a high temperature, and is melted to generate gas, which can affect the surface of the molded article, thereby causing molding defects.

The extruder body 56 includes an exhaust hole formed at one side thereof to exhaust the gas generated inside the extruder body 56, and an exhaust member 70 connected to the exhaust hole to forcibly exhaust the gas from the extruder body 56 to the outside. Here, the extrude member 70 includes an exhaust pipe, an exhaust motor, and an exhaust fan.

The molding powder is a mixture of a variety of materials including the thermosetting resin and the thermoplastic resin. Here, since the extruder body 56 is designed to allow the molding powder to move along the extruder body 56 and be completely melted at a portion near the ejection port 58, the exhaust hole and the exhaust member 70 may be formed at portions of the extruder body 56 near the ejection port 58.

In more detail, assuming the ejection port 58 is a start point set to 0 and one end of the extruder body 56 facing the generator 54 is a terminal point set to 100, the exhaust member 70 may be disposed at a point located between 20 to 50 points.

The ejection port 58 is provided with an extrusion die in which a through-hole corresponding to the shape of the molded article is formed.

The extrusion die is manufactured in consideration of extrudability and formability, and has a single mold or plural molds as necessary.

A detailed configuration and operation of the mixer 40 and the extruder 50 are apparent to those skilled in the art, and a detailed description thereof will be omitted herein.

Next, a method for manufacturing a molded article with crushed chips of a thermosetting plastic according to one embodiment of the present invention will be described. The method according to this embodiment comprises: performing primary crushing of an article formed from a thermosetting plastic to produce fragments 3 of the article in Operation S10; performing secondary crushing of the fragments 3 subjected to the primary crushing with a crusher 10 to produce crushed chips in Operation S20; mixing a resin material and an additive with the crushed chips to produce a molding powder in Operation S30; and performing extrusion molding of the molding powder in Operation S40.

The article of the thermosetting plastic crushed in Operation S10 comprises at least one of SMC (sheet molding compound) and BMC (bulk molding compound).

The article of the thermosetting plastic comprising at least one of the SMC and the BMC comprises glass fibers. In this embodiment, the article of the thermosetting plastic, i.e. a door, is crushed to a size of about 400×400 mm. However, the present invention is not limited thereto, and the article may be fragmented to any proper size so as to be crushed by the crusher 10.

For the primary crushing in Operation S10, the article of the thermosetting plastic is manually crushed by a worker with a manual instrument, an electric device, or the like.

After the primary crushing in Operation S10, the fragments 3 are contained in a conveying case 1 and carried to the crusher 10. Then, the fragments 3 are input to and crushed by the crusher 10 for the secondary crushing in Operation S20.

That is, although the molded article of the thermosetting plastic is manually crushed by the worker for the primary crushing in Operation S10, the secondary crushing in Operation S20 is the first operation carried out by means of a machine.

Such crushing operations of the thermosetting plastic provide the crushed chips applicable to extrusion molding with a minimized crushing degree, thereby minimizing load to the crusher 10 while enhancing durability thereof. Further, a recycled article produced by the extrusion molding contains a relatively great amount of glass fibers, which increase the strength of the recycled article.

When input to the crusher 10 through the input port 12, the fragments 3 are guided to the blade unit 20 by the crushing guide 14 and the screen 16.

The blade unit 20 is rotated by the motor 18. Here, among the fragments 3, some fragments having a relatively large size are crushed by the cutting members 30 after being introduced into the spaces 60, and the other fragments are crushed before being introduced into the spaces 60.

The spaces 60 serve to facilitate crushing of the fragments having a relatively large size. When the fragments are crushed to crushed chips of a preset size, the crushed chips are dropped toward a discharge opening 19 through the apertures 17 of the screen 16.

The crushed chips have a particle size of 5˜15 mm, so that the crushed chips containing the glass fibers can be maintained in a large size, thereby enabling an increase in strength of the molded article, which will be formed by the extrusion molding with the crushed chips.

If the crushed chips have a particle size less than 5 mm, the crusher 10 can encounter deterioration in durability due to crushing of the glass fibers having a great strength. If the crushed chips have a particle size greater than 15 mm, it can be difficult to perform the extrusion molding with such crushed chips.

In Operation S30, the resin material resin material comprises a thermoplastic resin, and the molding powder contains at most 70% of the crushed chips.

The thermoplastic resin may comprise various kinds of thermoplastic resins, such as general thermoplastic resins, thermoplastic resin for recycling, and the like.

On the other hand, the higher the mixing ratio of the crushed chips of the thermosetting plastic in the molding powder, the higher the dimensional stability and strength of the molded article formed from the molding powder. However, if the amount of the crushed chips exceeds 70% in the molding powder, the extrusion molding of the article can encounter some problems.

Since the SMC and the BMC used as the raw material of the crushed chips have a high specific weight of 1.8˜2.2, azodicarbonamide (ADCA) is used as a foaming agent to lower the specific weight of the molded article.

Thus, after supplying the crushed chips, the thermoplastic resin, and the foaming agent to the mixer body 42, the mixer cover 44 is closed and the mixer 50 is operated to produce the molding powder which has the respective components uniformly mixed therein.

The molding powder contains 0.05˜0.2% of ADCA.

Although ADCA is generally used as a subsidiary agent of wheel flour, it is used to lower the specific weight of the article in the present invention.

In Operation S40, when the extruder 50 is operated with the molding powder received in the supply part 52, the screws inside the extruder body 56 are rotated by the rotational power of the generator 54 to compress the molding powder toward the ejection port 58, thereby molding a desired article.

Further, according to an embodiment of the present invention, foam extrusion is carried out to lower the specific weight of the molding powder containing the SMC and/or the BMC.

According to another embodiment of the present invention, the crushed chips are crushed again by the crusher 10 to produce a crushed powder if there is a need for accuracy with respect to the molded article formed using the crushed chips of the thermosetting plastic.

Additionally, the molding powder may be produced by mixing the resin material and the additive with the crushed powder or by adding the resin material and the additive to a mixture of the crushed powder and the crushed chips.

The molded article according to the present invention is manufactured by the aforementioned method of manufacturing the molded article using the crushed chips of the thermosetting plastic.

As apparent from the above description, in manufacture of a molded article using crushed chips of a thermosetting plastic by the apparatus and method according to the present invention, an article formed from a thermosetting plastic comprising SMC and/or BMC is crushed to a particle size of 5 to 15 mm by a crusher, followed by mixing with a resin material and an additive, and extrusion molding to manufacture a desired molded article, so that the article formed from the thermosetting plastic comprising the SMC and/or the BMC can be reused without using high strength crush blades and a special crusher, thereby preventing environmental damage and achieving cost reduction resulting from recycling of resources.

Additionally, according to the present invention, a fastening structure between cutting members and rotational members, which are used for crushing the article formed from the thermosetting plastic comprising the SMC and/or the BMC, enables more convenient maintenance and repair of the cutting members, thereby improving workability.

Moreover, according to the present invention, the cutting members constitute a V-shape and sequentially contact each other from both sides to generate a low operating load, so that the crusher has improved durability.

Although the present invention has been described with reference to the embodiments and the accompanying drawings, it will be apparent to those skilled in the art that the embodiments are given by way of illustration, and that various modifications and equivalent embodiments can be made without departing from the spirit and scope of the present invention as set forth in the following claims.

What is claimed is:

1. An apparatus for manufacturing a molded article using crushed chips of a thermosetting plastic, comprising:
a crusher to crush fragments of an article of a thermosetting plastic to produce crushed chips, the fragments of the article having been subjected to primary crushing;
a mixer to mix a resin material and an additive with the crushed chips to produce a molding powder; and
an extruder to perform extrusion molding of the molding powder.

2. The apparatus according to claim 1, wherein the crusher comprises:
an input port opened at an upper side of the crusher through which the fragments of the article are input;
a crushing guide having a curved surface to guide the input fragments of the article to a lower side of the crusher;
a blade unit rotatably disposed inside the crushing guide and connected with a motor to crush the fragments of the article to produce the crushed chips; and
a screen spaced apart from the blade unit and formed with apertures through which the crushed chips are discharged.

3. The apparatus according to claim 2, wherein the blade unit comprises:
a rotational shaft to which a rotational force is transmitted from the motor;
plate-shaped rotational members rotatably secured to the rotational shaft and spaced at predetermine intervals from each other; and
cutting members, each being secured along one side of each rotational member, to crush the fragments.

4. The apparatus according to claim 3, wherein the cutting members mounted on the rotational members are spaced from one another at 120 degree intervals around the rotational shaft.

5. The apparatus according to claim 3, wherein the cutting members are secured to the rotational members via bolt fastening.

6. The apparatus according to claim 3, wherein each of the cutting members is divided into a left side blade and a right side blade, and the left and right side blades are mounted in a V-shape on the rotational member to define a central angle of 15˜175 degrees at a central part between the left and right side blades.

7. The apparatus according to claim 3, wherein the blade unit have a space defined between the rotational members connected with each other via the rotational shaft and the cutting members to facilitate introduction of the fragments into the blade unit and crushing of the fragments by the cutting members.

8. The apparatus according to claim 1, wherein the extruder comprises an exhaust hole formed at one side thereof to exhaust a gas, and an exhaust member connected to the exhaust hole to forcibly exhaust the gas from extruder to an outside thereof.
